(19) United States
(12) Patent Application Publication
(10) Pub. No.: US 2024/0104539 A1
(43) Pub. Date: Mar. 28, 2024

(54) READING DEVICE AND METHOD

(71) Applicant: TOSHIBA TEC KABUSHIKI KAISHA, Tokyo (JP)

(72) Inventor: Takuya Takasu, Shizuoka Shizuoka (JP)

(21) Appl. No.: 18/314,853

(22) Filed: May 10, 2023

(30) Foreign Application Priority Data
Sep. 22, 2022 (JP) 2022-150880

(51) Int. Cl. G06Q 20/20; G06K 7/14

(52) U.S. Cl. CPC G06Q 20/208; G06K 7/1413; G06K 7/1417

(57) ABSTRACT

According to one embodiment, a reading device and a method capable of improving operability of an operator without impairing an appearance of a commodity and preventing forgetting to read privilege information such as discount information are provided. A reading device according to an embodiment includes: an imaging unit configured to image a reading target; a reading unit configured to read, from an image captured by the imaging unit, first information by first processing and second information by second processing different from the first processing, the first information being indicated by a symbol printed with a digital watermark and the second information being indicated by a symbol printed with a digital watermark and different from the first information; and an output unit configured to output information read by the reading unit.

### CROSS-REFERENCE TO RELATED APPLICATION

This application is based upon and claims the benefit of priority from Japanese Patent Application No. 2022-150880, filed on Sep. 22, 2022, the entire contents of which are incorporated herein by reference.

### FIELD

Embodiments described herein relate generally to a reading device and a method.

### BACKGROUND

In related art, there is known a reading device that is used in, for example, a point of sale (POS) terminal and reads commodity information on a commodity purchased by a customer. The reading device images a symbol such as a bar code or a two-dimensional code attached to a commodity sold in a store, reads commodity information on the commodity from the captured image, and outputs the commodity information to a POS terminal. The POS terminal executes, based on the input commodity information, payment for a customer to pay.

In recent years, a symbol indicating information on a commodity such as a commodity code (hereinafter also referred to as a “code symbol”) is printed using a digital watermark technique. The digital watermark technique is a technique for embedding specific information in a medium in a form imperceptible to humans. For example, a code symbol printed with a digital watermark is printed on a commodity package in a state imperceptible to humans, and commodity information indicated by the code symbol is read by a reading device using dedicated software.

The code symbol printed with a digital watermark cannot be recognized by a customer who purchases the commodity, and thus there is an advantage that an appearance of the commodity is not impaired even if a large number of code symbols are printed on an entire surface of the commodity package. By printing a large number of code symbols on the entire surface of the commodity package, the commodity information can be read no matter how the commodity is held in front of a reading window of the reading device. Accordingly, the code symbol based on a digital watermark can improve operability of an operator without impairing the appearance of the commodity.

However, in the related art using a digital watermark, discount information on a discount seal attached to the commodity may be forgotten to be read. Specifically, in related art, if a commodity is discounted, a discount seal or a flag seal indicating that the discount seal is attached (hereinafter also referred to as a “discount seal or the like”) is attached to a commodity to be discounted in a vicinity of the code symbol. Accordingly, the reading device can recognize the discount seal or the like by imaging the discount seal or the like at the same time as when the code symbol is imaged, thereby preventing forgetting to read the discount information. However, since a large number of code symbols printed with a digital watermark are printed on the entire surface of the commodity package, the code symbols are also present at positions away from the discount seal or the like.

Therefore, if the reading device images the code symbol at a position away from the discount seal or the like and reads the commodity information, the captured image does not include the discount seal or the like. As a result, the reading device may not recognize the discount seal or the like, which leads to forgetting to read the discount information.

### DESCRIPTION OF THE DRAWINGS

FIG. 1 is a perspective view showing an overall configuration of a POS system including a reading device according to an embodiment;

FIG. 2 is a block diagram showing a main hardware configuration of the reading device;

FIG. 3 shows a data configuration of a pattern information table stored in a storage unit;

FIG. 4 shows a commodity package on which a large number of symbols indicating a commodity code are printed with a digital watermark;

FIG. 5 shows a flag seal on which a large number of symbols indicating flag information are printed;

FIG. 6 shows the commodity package attached with the flag seal;

FIG. 7 is a block diagram showing a main functional configuration of a control unit;

FIG. 8 is a flowchart showing a flow of reading; and

FIG. 9 is a flowchart showing a flow of reading according to a modification.

### DETAILED DESCRIPTION

In general, according to one embodiment, a reading device and a method capable of improving operability of an operator without impairing an appearance of a commodity and preventing forgetting to read privilege information such as discount information are provided.

A reading device according to an embodiment includes: an imaging unit configured to image a reading target; a reading unit configured to read, from an image captured by the imaging unit, first information by first processing and second information by second processing different from the first processing, the first information being indicated by a symbol printed with a digital watermark and the second information being indicated by a symbol printed with a digital watermark and different from the first information; and an output unit configured to output information read by the reading unit.

Hereinafter, a reading device and a method according to the present embodiment will be described with reference to the drawings. Exemplary embodiments described herein are not limited to those to be described later. For example, in the present embodiment, an example in which the reading device is applied to a POS system installed in a retail store or the like will be described, but an exemplary embodiment is not limited thereto. The reading device may be any device that reads, from a symbol, information indicated by the symbol, and is widely applicable to other fields.

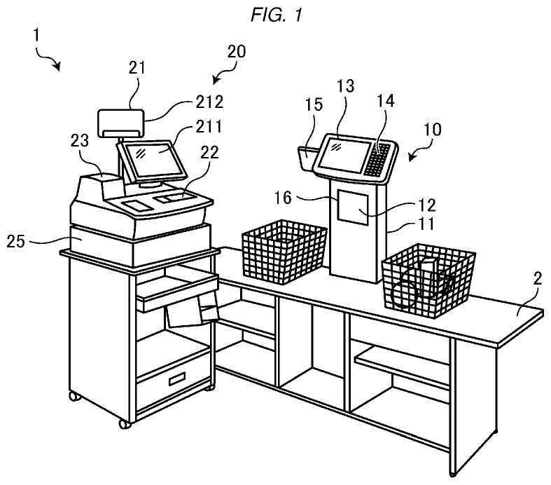

FIG. 1 is a perspective view showing an overall configuration of a POS system 1. The POS system 1 includes a reading device 10 and a POS terminal 20 that executes payment or the like based on information read by the reading device 10. The POS system 1 according to the present embodiment is a POS system for a store clerk in a store to operate, or may be a self-service POS system for a customer to operate. In the following description, the store clerk who operates the POS system 1 may be referred to as an “operator”.

The reading device 10 is erected on a sacker table 2 on which a shopping basket or the like containing a commodity is placed, at a place between an operator and a customer substantially facing each other (a substantially central portion). The POS terminal 20 is provided in the vicinity of one end of the sacker table 2. The reading device 10 and the POS terminal 20 are communicably connected by a transmission path (not shown). The POS system 1 includes the reading device 10 and the POS terminal 20.

The POS terminal 20 executes, based on data such as a commodity code or discount information read by the reading device 10, registration of a commodity to be purchased by a customer. Here, the commodity code is information identifying a commodity, and is an example of commodity identification information. The discount information is, for example, information indicating a discount amount, and is an example of privilege information on a privilege of the commodity.

The POS terminal 20 receives, from the reading device 10, a commodity code read from a code symbol attached to a commodity by the reading device 10 or discount information read from a discount seal attached to the commodity by the reading device 10. The POS terminal 20 registers, based on the received commodity code and discount information, commodity information of the commodity to be purchased by the customer (a commodity name, a price, a commodity code, etc.) to execute registration. The registration executed by the POS terminal 20 is also referred to as commodity registration.

The POS terminal 20 executes payment based on the registered commodity information. The payment is processing for paying for the commodity to be purchased by the customer based on the registered commodity information. The POS terminal 20 can execute payment for cash settlement, and payment for cashless settlement such as credit card settlement, code settlement, and electronic money settlement.

As shown in FIG. 1, the POS terminal 20 is installed on a drawer 25 that accommodates coins and banknotes in a freely removable manner. The POS terminal 20 includes a display 21, an input device 22 such as a keyboard, and a receipt printer 23. The POS terminal 20 also includes a card reader, a two-dimensional code reader (not shown) and the like. The card reader and the two-dimensional code reader are used to execute the payment for cashless settlement.

The display 21 includes an operator display 211 and a customer display 212. The operator display device 211 displays, to the operator, various kinds of information such as commodity information of registered commodities and a total amount of transactions. The customer display device 212 displays, to the customer, various kinds of information such as a total amount of transactions.

The input device 22 includes a keyboard having various keys. The various keys provided in the keyboard include, for example, numerical keys for inputting a commodity code or the price of a commodity not attached with a code symbol such as a bar code, a subtotal key for declaring calculation of a total sales amount, a closing key for declaring that a transaction is closed and payment is settled, a confirmation key for confirming numerical input by the numerical keys, and a clear key for clearing the input.

The receipt printer 23 is implemented by, for example, a thermal printer, and dispenses a receipt on which information on one transaction is printed. The information on one transaction is commodity information of a commodity to be purchased by a customer, a total amount of one transaction, or the like.

Next, the reading device 10 will be described in detail. As shown in FIG. 1, the reading device 10 includes a main body 11, an imaging unit 12, a first display unit 13, an operation unit 14, and a second display unit 15.

The main body 11 is formed in a substantially rectangular parallelepiped shape, and is erected on the sacker table 2. The height of the main body 11 is set according to the height of a general operator. An imaging window 16 is provided in the main body 11 on a standing position side of the operator. The imaging unit 12 is installed inside the imaging window 16. The imaging unit 12 includes an imaging device such as a charge coupled device (CCD) or a complementary MOS (CMOS), and an imaging lens.

The imaging unit 12 continuously images a commodity appearance such as a commodity package held in front of the imaging window 16 at predetermined intervals. The imaging unit 12 stores the captured image. The imaging unit 12 images a commodity package on which a code symbol printed with a digital watermark, a character and an illustration that is printed with normal printing and can be perceived by humans, and the like are printed. The imaging unit 12 images a discount seal attached to the commodity package. The code symbol and the discount seal indicate specific information, and are examples of a reading target to be imaged by the imaging unit 12.

The reading device 10 extracts the code symbol printed with a digital watermark from the image imaged by the imaging unit 12, and reads the commodity code from the extracted code symbol. In other words, the reading device 10 extracts the commodity code from the code symbol obtained by encoding the commodity code. The commodity code encoded into the code symbol is an example of first information indicated by the code symbol printed with a digital watermark.

The reading device 10 extracts another code symbol printed with a digital watermark from the image imaged by the imaging unit 12, and reads flag information from the extracted code symbol. The flag information is information indicating that a discount seal is attached to a commodity. The flag information encoded into the code symbol is information on a privilege (discount) for the customer, and is an example of second information indicated by the code symbol printed with a digital watermark.

The first display unit 13 is a display device that displays information to the operator, and is provided above the imaging window 16. The first display unit 13 is, for example, a display device with a touch panel including a display device such as a liquid crystal display (LCD). The first display unit 13 displays, for example, the commodity information acquired based on the commodity code read by the reading device 10. The reading device 10 acquires the commodity information from the POS terminal 20 that stores a commodity master in which the commodity code and the commodity information are associated with each other.

The operation unit 14 is provided adjacent to the first display unit 13. The operation unit 14 is implemented by a keyboard and includes various keys for inputting a commodity code. The operation unit 14 is operated to input a commodity code of a commodity attached with an unreadable code symbol or a commodity not attached with a code symbol, or the like.

The second display unit 15 is a display device that displays information to the customer and is supported by a side portion of the main body 11. The second display unit 15 is, for example, a display device with a touch panel including a display device such as an LCD. The second display unit 15 displays, for example, commodity information that is based on the commodity code read by the reading device 10 from the code symbol attached to the commodity.

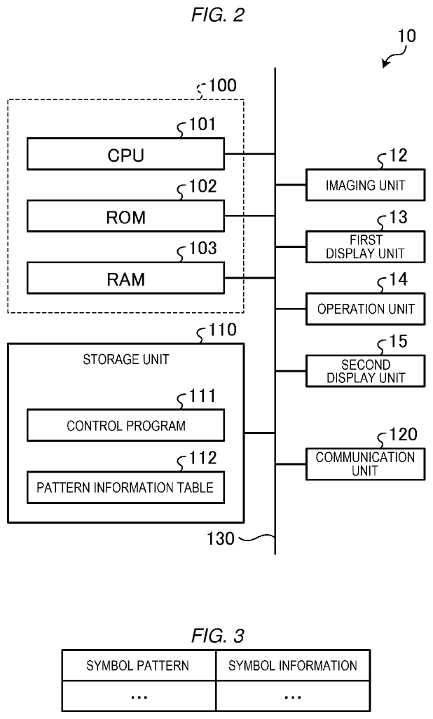

FIG. 2 is a block diagram showing an example of a main hardware configuration of the reading device 10. The reading device 10 includes a control unit 100, a storage unit 110, the imaging unit 12, the first display unit 13, the operation unit 14, the second display unit 15, and a communication unit 120. The control unit 100, the storage unit 110, the imaging unit 12, the first display unit 13, the operation unit 14, the second display unit 15, and the communication unit 120 are coupled to each other via a bus 130 or the like.

The control unit 100 has a computer configuration including a central processing unit (CPU) 101, a read only memory (ROM) 102, and a random access memory (RAM) 103. The CPU 101, the ROM 102, and the RAM 103 are coupled to each other via the bus 130.

The CPU 101 controls an overall operation of the reading device 10. The ROM 102 stores various programs such as a program used to drive the CPU 101 and various kinds of data. The RAM 103 is used as a work area of the CPU 101, and loads various programs and various kinds of data stored in the ROM 102 and the storage unit 110. The control unit 100 executes various control processes of the reading device 10 by the CPU 101 acting according to a control program stored in the ROM 102 or the storage unit 110 and loaded onto the RAM 103.

The storage unit 110 is implemented by a storage medium such as a hard disk drive (HDD) or a flash memory, and maintains stored contents even if power is off. The storage unit 110 stores a control program 111 and a pattern information table 112.

The control program 111 is various control programs for reading the commodity code and the discount information from the image captured by the imaging unit 12. Specifically, the control program 111 is a program for implementing a function of controlling the imaging unit 12, a function of extracting the code symbol printed with a digital watermark from the image imaged by the imaging unit 12, a function of decoding the extracted code symbol and reading information indicated by the code symbol, a function of extracting the discount seal from the image imaged by the imaging unit 12, a function of reading the discount information indicated by the extracted discount seal, and the like.

The pattern information table 112 is used if the control unit 100 reads information from a print pattern of the code symbol printed with a digital watermark on the commodity package or the like. FIG. 3 shows a data configuration of the pattern information table 112. The pattern information table 112 stores a symbol pattern and symbol information in association with each other.

The symbol pattern is information specifying a print pattern of a code symbol printed with a digital watermark on the commodity package or a seal member to be described later. For example, the symbol pattern is image data of the print pattern of the code symbol.

The symbol information is information indicated by the corresponding symbol pattern. For example, the symbol information is a commodity code of each commodity to be sold in the store and flag information indicating that a discount seal is attached to the commodity. As in a modification to be described later, if a code symbol indicating discount information, that is, a code symbol obtained by encoding the discount information is printed with a digital watermark, the discount information is registered as the symbol information.

The control unit 100 extracts the code symbol printed with a digital watermark on the commodity package or the seal member, and recognizes the print pattern of the extracted code symbol. The control unit 100 reads the symbol information corresponding to the recognized print pattern from the pattern information table 112.

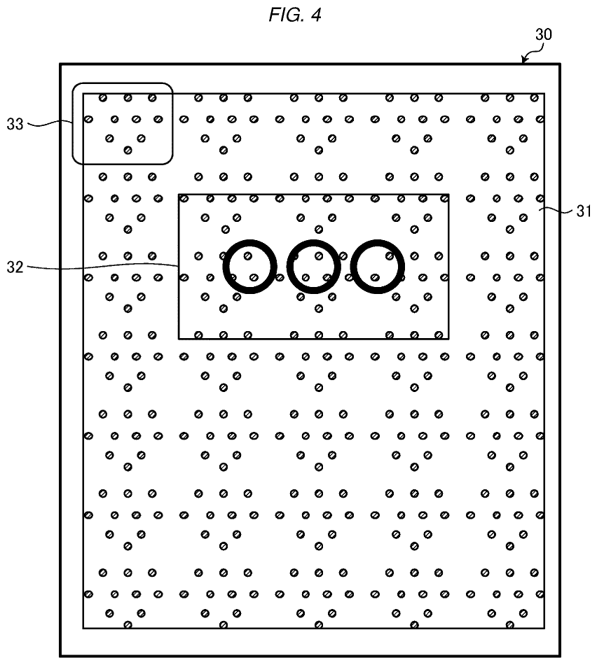

Here, the commodity package on which the code symbol is printed with a digital watermark will be described. FIG. 4 shows a commodity package 30 on which a large number of code symbols indicating a commodity code are printed with a digital watermark. The commodity package 30 according to the present embodiment is a bag that accommodates a commodity therein, but is not limited thereto. The commodity package 30 may be a box that accommodates a commodity therein.

A commodity design region 31 is formed on the front surface of the commodity package 30. In the commodity design region 31, an illustration of a commodity (not shown) and the like are printed. The commodity design region 31 includes a commodity name printing region 32 in which a commodity name is printed. A character and the illustration in the commodity design region 31 are printed with normal printing, and can be perceived by humans. The customer can select a commodity to be purchased by viewing the character and the illustration printed in the commodity design region 31.

A large number of code symbols 33 are printed with a digital watermark using cyan ink over the entire commodity design region 31. The code symbol 33 is formed with an aggregate of a plurality of dots, and indicates a commodity code identifying a commodity. The code symbol 33 may be formed with a bar code or a two-dimensional code. A large number of code symbols 33 are printed over the entire rear surface of the commodity package 30 as in the front surface.

The large number of code symbols 33 are recognizable to the reading device 10 but unperceivable by humans, and thus the appearance of the commodity package 30 recognized by the customer is not impaired. Unperceivable by humans means cannot be perceived by humans at first glance, and includes a case where the code symbol 33 can be recognized when looked at carefully.

Since the large number of code symbols 33 are printed over the entire commodity package 30, the reading device 10 can read the commodity code no matter how the operator holds the commodity package 30 in front of the imaging window 16. Therefore, operability if the operator causes the reading device 10 to read the commodity code can be improved.

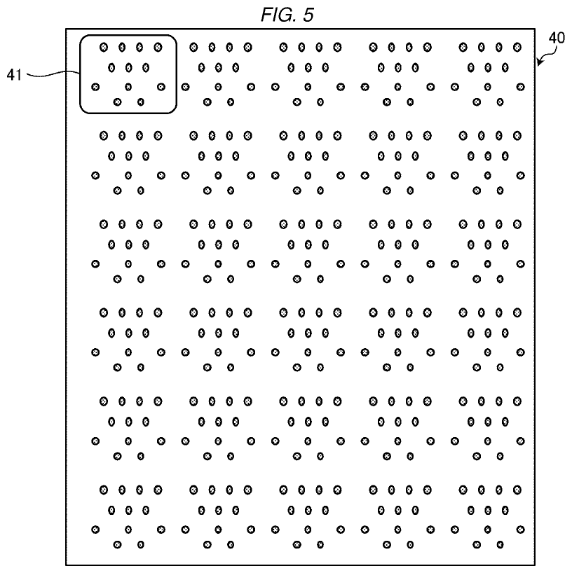

Next, the seal member on which the code symbol is printed with a digital watermark will be described. FIG. 5 shows a seal member 40 on which a large number of symbols indicating flag information are printed with a digital watermark. The seal member 40 is attached to the commodity package 30 together with the discount seal on which the discount amount is printed if the store offers discount.

The seal member 40 is made of a transparent material, and a large number of code symbols 41 are printed with a digital watermark using magenta ink over the entire seal member 40. The code symbol 41 is formed with an aggregate of a plurality of dots, and indicates flag information indicating that a discount seal is attached to the commodity package 30. The code symbol 41 may also be formed with a bar code or a two-dimensional code instead of an aggregate of dots.

It is desirable to cover all of the large number of code symbols 33 printed on the commodity package 30 by one or a plurality of seal members 40, but it is not necessary to cover all of the code symbols 33. In the present embodiment, the size of the seal member 40 is equal to or larger than the size of the commodity design region 31 of the commodity package 30. Therefore, by attaching the seal member 40 to the commodity design region 31 in an overlapping manner, the seal member 40 can cover all of the large number of code symbols 33 printed in the commodity design region 31. Accordingly, regardless of which code symbol 33 is imaged by the imaging unit 12, one of the code symbols 41 can be imaged together. The seal member 40 can cover the entire rear surface of the commodity package 30.

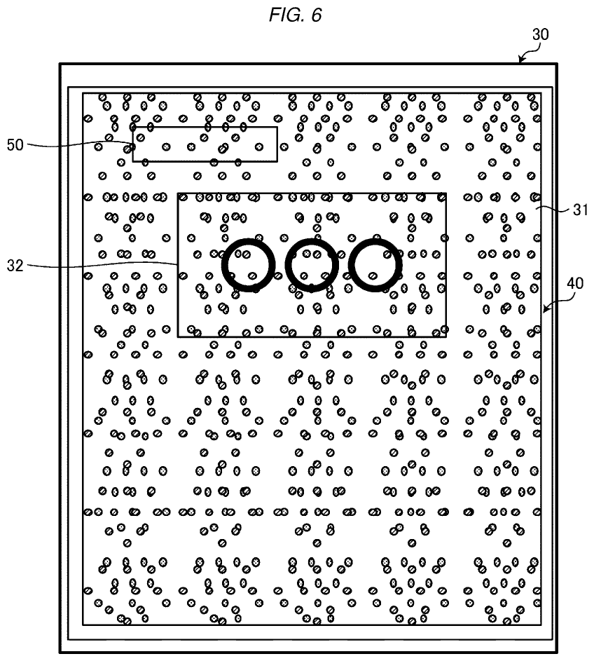

FIG. 6 shows the commodity package 30 attached with the seal member 40. The seal member 40 covers all of the large number of code symbols 33 printed in the commodity design region 31. The seal member 40 is attached so as to cover all of the code symbols 33 printed on the rear surface of the commodity package 30. Therefore, the code symbol 33 based on a digital watermark using cyan ink and the code symbol 41 based on a digital watermark using magenta ink overlap each other. The seal member 40 is made of a transparent material as described above, and the code symbol 41 is printed with a digital watermark, so that the appearance of the commodity package 30 cannot be impaired.

A discount seal 50 is attached to the commodity package 30. The discount seal 50 is printed with normal printing so that the customer can perceive the discount amount or the like. Here, the discount is a concept including not only a discount of deducting a certain amount from the price of the commodity, but also a discount of deducting an amount with a certain ratio from the price of the commodity. The discount is an example of the privilege of the commodity. The privilege is not limited to the discount, and may be, for example, granting of points.

The customer who views the discount seal 50 attached to the commodity package 30 can recognize the discount amount of the commodity in the commodity package 30. The reading device 10 recognizing the discount seal 50 attached to the commodity package 30 can analyze the discount amount printed on the discount seal 50 by imaging.

Referring back to FIG. 2, the hardware configuration of the reading device 10 will be described. The configurations and functions of the imaging unit 12, the first display unit 13, the operation unit 14, and the second display unit 15 are as described in the description of FIG. 1.

The communication unit 120 is an interface for communicating with an external device such as the POS terminal 20. The control unit 100 can transmit and receive information (data) to and from the external device by being coupled to the external device via the communication unit 120.

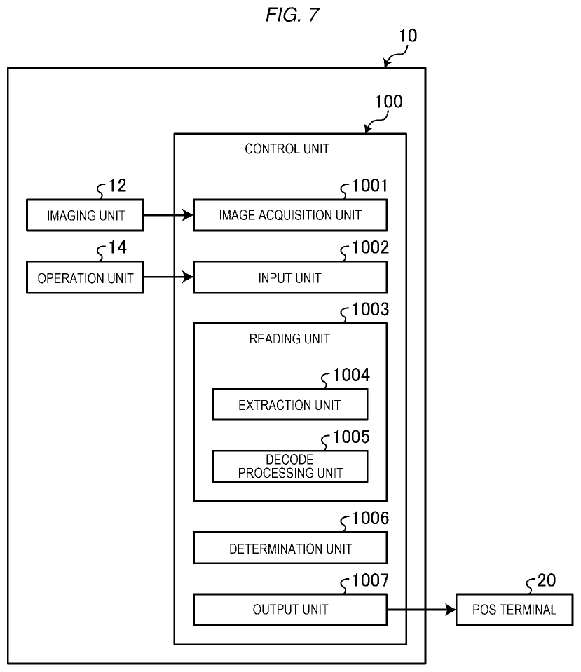

Next, a functional configuration of the control unit 100 of the reading device 10 will be described. FIG. 7 is a block diagram showing a main functional configuration of the control unit 100 of the reading device 10. The control unit 100 functions as an image acquisition unit 1001, an input unit 1002, a reading unit 1003, an extraction unit 1004, a decode processing unit 1005, a determination unit 1006, and an output unit 1007 by the CPU 101 acting according to the control program stored in the ROM 102 or the storage unit 110. The functions may be implemented by using hardware such as a dedicated circuit.

The image acquisition unit 1001 acquires image data obtained by imaging by the imaging unit 12. The image acquisition unit 1001 appropriately acquires a frame image (a captured image) imaged by the imaging unit 12. The frame image obtained by imaging the commodity package 30 attached with the discount seal 50 includes images of the code symbol 33 and the code symbol 41 printed with a digital watermark.

Various kinds of information are input to the input unit 1002 from the operation unit 14. For example, a start instruction is input to the input unit 1002 from the operation unit 14 to start reading the commodity code. If the start instruction is input to the input unit 1002, the imaging unit 12 starts imaging. An end instruction is input to the input unit 1002 from the operation unit 14 to end reading. If the end instruction is input to the input unit 1002, the imaging unit 12 stops imaging, and the output unit 1007 transmits, to the POS terminal 20, information indicating that reading of the commodity code is completed.

The commodity code is input to the input unit 1002 from the operation unit 14. The commodity code input to the input unit 1002 from the operation unit 14 is a commodity code of a commodity attached with an unreadable code symbol or a commodity not attached with a code symbol.

The reading unit 1003 reads information indicated by the code symbols 33 and 41 included in the frame image imaged by the imaging unit 12. The reading unit 1003 reads discount information indicated by the discount seal 50 included in the frame image imaged by the imaging unit 12. The reading unit 1003 includes the extraction unit 1004 and the decode processing unit 1005.

The extraction unit 1004 extracts the code symbols 33 and 41 and the discount seal 50 from the frame image acquired by the image acquisition unit 1001. The decode processing unit 1005 decodes the code symbols 33 and 41 extracted by the extraction unit 1004 and analyzes and reads the discount amount printed on the discount seal 50 and extracted by the extraction unit 1004.

For example, the extraction unit 1004 extracts the code symbol 33 printed with a digital watermark using cyan ink from the frame image acquired by the image acquisition unit 1001. The code symbol 33 printed with a digital watermark using cyan ink is extracted by a known image processing technique. The decode processing unit 1005 decodes the code symbol 33 extracted by the extraction unit 1004 to read the commodity code. The reading of the commodity code (the first information) by the extraction unit 1004 and the decode processing unit 1005 is also referred to as first processing.

In other words, the reading unit 1003 reads the commodity code (the first information), which is indicated by the code symbol printed with a digital watermark, by the first processing from the image captured by the imaging unit 12. At this time, the reading unit 1003 extracts a code symbol printed in a specific color (cyan) from the captured image by the first processing.

The extraction unit 1004 extracts the code symbol 41 printed with a digital watermark using magenta ink from the frame image acquired by the image acquisition unit 1001. The code symbol 41 printed with a digital watermark using magenta ink is extracted by the known image processing technique. The decode processing unit 1005 decodes the code symbol 41 extracted by the extraction unit 1004 and reads the flag information. The reading of the flag information (the second information) by the extraction unit 1004 and the decode processing unit 1005 is also referred to as second processing.

In other words, the reading unit 1003 reads the flag information (the second information), which is indicated by the code symbol printed with a digital watermark and different from the commodity code (the first information), by the second processing different from the first processing from the image captured by the imaging unit 12. At this time, the reading unit 1003 extracts a code symbol printed in a color (magenta) different from the specific color (cyan) from the captured image by the second processing.

The extraction unit 1004 extracts the discount seal 50 from the frame image acquired by the image acquisition unit 1001 using the known image processing technique. The decode processing unit 1005 performs image analysis on the discount seal 50 extracted by the extraction unit 1004 and reads the discount amount printed on the discount seal 50. The discount amount printed on the discount seal 50 is an example of the discount information. The decode processing unit 1005 may read the discount amount printed on the discount seal 50 by machine learning or the like.

The determination unit 1006 determines whether the reading unit 1003 reads the information from the frame image. For example, the determination unit 1006 determines whether the reading unit 1003 extracts the code symbol 33 from the frame image and reads the commodity code. The determination unit 1006 determines whether the reading unit 1003 extracts the code symbol 41 from the frame image and reads the flag information. Further, the determination unit 1006 determines whether the reading unit 1003 extracts the discount seal 50 from the frame image and reads the discount information.

The output unit 1007 outputs the information read by the reading unit 1003. For example, if the commodity to be purchased by the customer is a discount commodity, the output unit 1007 transmits, to the POS terminal 20, the commodity code and the discount information read by the reading unit 1003. The POS terminal 20 calculates the price after the discount based on the received commodity code and discount information. The price after the discount may be calculated by the control unit 100, and the output unit 1007 may transmit the commodity code and the amount after the discount to the POS terminal 20. In other words, the output unit 1007 may output only a part of the information read by the reading unit 1003. If the commodity to be purchased by the customer is not a discount commodity, the output unit 1007 transmits, to the POS terminal 20, the commodity code read by the reading unit 1003.

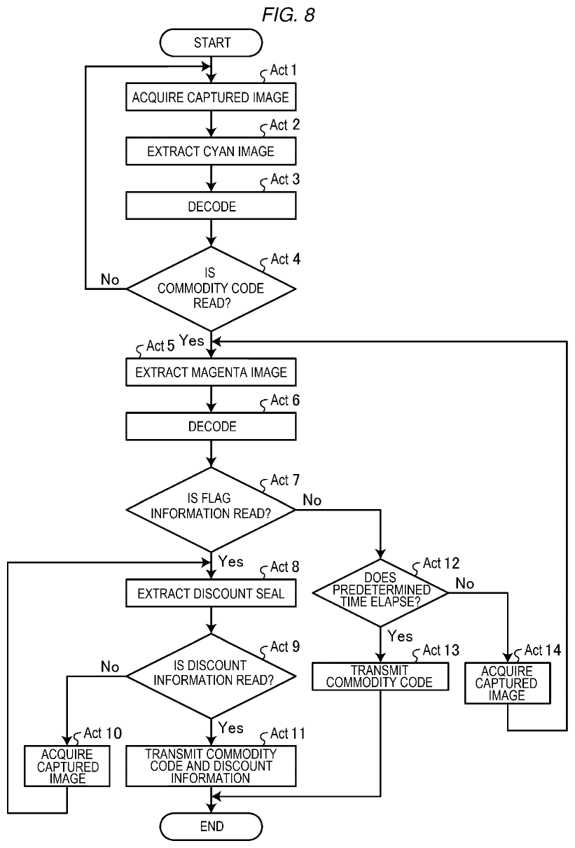

Next, the reading executed by the reading device 10 will be described. FIG. 8 is a flowchart showing a flow of the reading executed by the control unit 100 of the reading device 10.

If the operator operates the operation unit 14 to input the start instruction to the input unit 1002, the image acquisition unit 1001 acquires the image captured by the imaging unit 12 (Act 1). The extraction unit 1004 extracts only the cyan image printed with a digital watermark from the captured image acquired by the image acquisition unit 1001 (Act 2).

The decode processing unit 1005 attempts to decode the code symbol 33 included in the cyan image (Act 3). The determination unit 1006 determines whether the commodity code is read by the decode processing unit 1005 (Act 4). If the commodity code cannot be read (No in Act 4) because the code symbol 33 cannot be extracted from the cyan image or the information cannot be read from the extracted code symbol 33, the control unit 100 returns to the processing in Act 1.

If the commodity code is read by the decode processing unit 1005 (Yes in Act 4), the extraction unit 1004 extracts only the magenta image printed with a digital watermark from the captured image acquired by the image acquisition unit 1001 (Act 5).

The decode processing unit 1005 attempts to decode the code symbol 41 included in the magenta image (Act 6). The determination unit 1006 determines whether the flag information is read by decoding performed by the decode processing unit 1005 (Act 7).

If the flag information is read by the decode processing unit 1005 (Yes in Act 7), the extraction unit 1004 attempts to extract the discount seal 50 from the captured image acquired by the image acquisition unit 1001 (Act 8). The determination unit 1006 determines whether the discount information is read by the decode processing unit 1005 (Act 9).

If the discount information cannot be read (No in Act 9) because the discount seal 50 cannot be extracted from the captured image acquired by the image acquisition unit 1001 or the information cannot be analyzed from the extracted discount seal 50, the image acquisition unit 1001 acquires a captured image separately imaged by the imaging unit 12 (Act 10). The control unit 100 returns to the processing in Act 8.

In the present embodiment, if the reading unit 1003 reads the flag information, the processing of acquiring the captured image and reading the discount information from the captured image is repeated until the reading unit 1003 reads the discount information. This is because if the reading unit 1003 reads the flag information, the discount seal 50 should be attached to the commodity package 30. However, the discount seal 50 attached to the commodity package 30 may be peeled off for some reason. Therefore, the control unit 100 may repeat the acquisition of the captured image and the reading of the discount information from the captured image for a predetermined time, and display error information after the predetermined time elapses.

If the discount information is read by the reading unit 1003 (Yes in Act 9), the output unit 1007 transmits, to the POS terminal 20, the commodity code and the discount information read by the reading unit 1003 (Act 11). Then, the control unit 100 ends the reading.

In the processing in Act 7, if the flag information cannot be read (No in Act 7) because the code symbol 41 cannot be extracted from the magenta image or the information cannot be read from the extracted code symbol 41, the control unit 100 determines whether a predetermined time elapses since the commodity code is read (Act 12). If the predetermined time elapses (Yes in Act 12), the output unit 1007 transmits the read commodity code to the POS terminal 20 (Act 13). In this case, the control unit 100 determines that the commodity in the captured image is not a discounted commodity, that is, is not a commodity attached with the discount seal 50. Then, the output unit 1007 transmits only the commodity code to the POS terminal 20. Thereafter, the control unit 100 ends the reading.

In the processing in Act 12, if the predetermined time does not elapse (No in Act 12), the image acquisition unit 1001 acquires the image captured by the imaging unit 12 (Act 14). Then, the control unit 100 returns to the processing in Act 5.

By the reading, the reading device 10 can read the commodity code indicated by the code symbol 33 printed with a digital watermark and the flag information indicated by the code symbol 41 printed with a digital watermark. The reading device 10 can read the discount information indicated by the discount seal 50 attached to the commodity package 30.

(Modification)

Next, a modification will be described. The modification is different from the above-described embodiment in that the reading device 10 reads discount information from the code symbol 41 printed on the seal member 40 with a digital watermark. In other words, the modification is different from the above-described embodiment in that a second information is not flag information but discount information indicating a content of a privilege for a customer.

In the modification, a configuration of the seal member 40 is the same as that in the above-described embodiment, but information encoded into the code symbol 41 is the discount information. Also in the modification, it is desirable to attach the separate discount seal 50 to the commodity package 30. This is to notify a customer of the discount information.

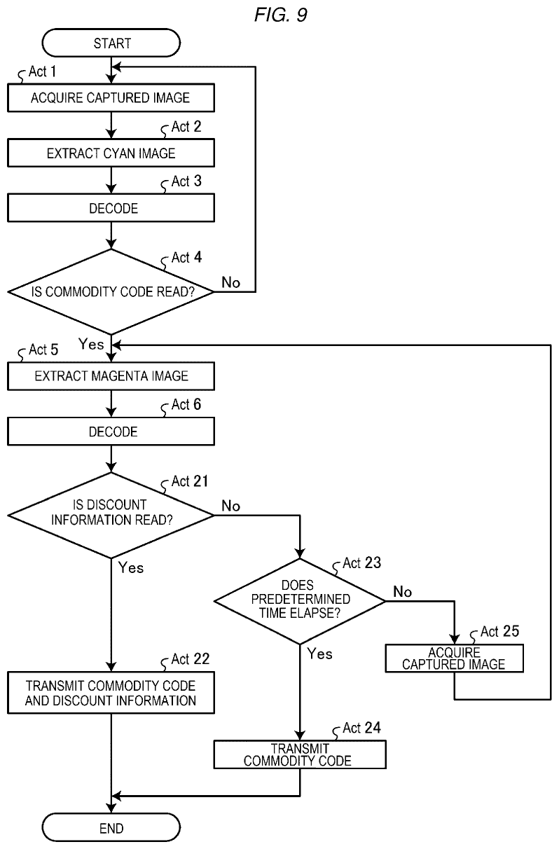

Reading executed by the reading device 10 will be described. FIG. 9 is a flowchart showing a flow of reading executed by the control unit 100 of the reading device 10 according to the modification. Processing similar to the reading according to the above-described embodiment is denoted by the same reference numeral, and description thereof may be omitted.

Through the processing in Act 1 to Act 4, a commodity code is read from the code symbol 33 printed with a digital watermark on the commodity package 30, as in the above-described embodiment. Decoding of the code symbol 41 printed on the seal member 40 is attempted by the processing in Act 5 and Act 6, as in the above-described embodiment.

The determination unit 1006 determines whether discount information is read from the code symbol 41 by decoding executed by the decode processing unit 1005 (Act 21). If the discount information is read by the decode processing unit 1005 (Yes in Act 21), the output unit 1007 transmits, to the POS terminal 20, the commodity code and the discount information read by the reading unit 1003 (Act 22). Then, the control unit 100 ends the reading.

In the processing in Act 21, if the discount information cannot be read (No in Act 21) because the code symbol 41 cannot be extracted from a magenta image or the information cannot be read from the extracted code symbol 41, the control unit 100 determines whether a predetermined time elapses since the commodity code is read (Act 23).

If the predetermined time elapses (Yes in Act 23), the output unit 1007 transmits the read commodity code to the POS terminal 20 (Act 24). In this case, the control unit 100 determines that the commodity in the captured image is not a discounted commodity, that is, is not a commodity attached with the seal member 40 on which the code symbol 41 indicating the discount information is printed, and the output unit 1007 transmits only the commodity code to the POS terminal 20. Then, the control unit 100 ends the reading.

In the processing in Act 23, if the predetermined time does not elapse (No in Act 23), the image acquisition unit 1001 acquires the image captured by the imaging unit 12 (Act 25). Then, the control unit 100 returns to the processing in Act 5.

By the reading, the reading device 10 can read the commodity code indicated by the code symbol 33 printed with a digital watermark and the discount information indicated by the code symbol 41 printed with a digital watermark. Accordingly, the operator does not need to align the discount seal 50 with the imaging window 16, and the operability of the operator can be further improved.

As described above, the reading device 10 according to the above embodiment includes: the imaging unit 12 configured to image a reading target; the reading unit 1003 configured to read, from an image captured by the imaging unit 12, a commodity code by first processing and flag information or discount information by second processing different from the first processing, the commodity code being indicated by a symbol printed with a digital watermark and the flag information or discount information being indicated by a symbol printed with a digital watermark and different from the commodity code; and the output unit 1007 configured to output information read by the reading unit 1003.

Accordingly, the reading device 10 can improve the operability of the operator without impairing the appearance of the commodity, and can prevent forgetting to read the privilege information such as discount information.

The reading unit 1003 of the reading device 10 according to the embodiment extracts a symbol printed in a specific color from the captured image by the first processing and extracts a symbol printed in a color different from the specific color from the captured image by the second processing.

Accordingly, the reading device 10 can easily distinguish between the symbol printed with a digital watermark of the specific color and the symbol printed with a digital watermark of the color different from the specific color. Accordingly, for example, even if the symbol indicating the commodity code and the symbol indicating the flag information or the discount information are superimposed on each other, both can be easily distinguished. Therefore, forgetting to read privilege information such as discount information can be more reliably prevented.

Further, the first information in the embodiment is a commodity code identifying a commodity, and the second information is flag information or discount information on a privilege of the commodity.

Accordingly, the reading device 10 can be suitable for a store in which commodities are sold.

The second information in the embodiment is flag information indicating that a label indicating a content of the privilege is attached to the commodity or information indicating the content of the privilege.

Accordingly, the reading device 10 can be made suitable for a volume sales store such as a supermarket in which a discount sale is performed on a daily basis.

In the above embodiment, the control program executed by the reading device 10 may be provided by being recorded in a computer-readable recording medium such as a CD-ROM. The control program executed by the reading device 10 according to the above embodiment may be stored in a computer connected to a network such as the Internet and provided by being downloaded via the network, or may further be provided via a network such as the Internet.

Although the embodiment according to the disclosure is described above, the embodiment is presented as an example and is not intended to limit the scope of the disclosure. The embodiment can be implemented in various other forms, and various omissions, substitutions, and changes can be made without departing from the gist of the disclosure. The accompanying claims and their equivalents are intended to cover such forms or modifications as would fall within the scope and spirit of the disclosure.

What is claimed is:

1. A reading device, comprising:
an imaging component configured to image a reading target;
a reading component configured to read, from an image captured by the imaging component, first information by first processing and second information by second processing different from the first processing, the first information indicated by a first symbol printed with a first digital watermark and the second information indicated by a second symbol printed with a second digital watermark and different from the first information; and
an output component configured to output information read by the reading component.

2. The reading device according to claim 1, wherein
the reading component extracts the first symbol printed in a first color from the captured image by the first processing, and extracts the second symbol printed in a second color different from the first color from the captured image by the second processing.

3. The reading device according to claim 1, wherein
the first information is commodity identification information identifying a commodity and the second information is privilege information on a privilege of the commodity.

4. The reading device according to claim 3, wherein
the second information is flag information indicating that a label indicating a content of the privilege is attached to the commodity.

5. The reading device according to claim 3, wherein
the second information is information indicating a content of the privilege.

6. The reading device according to claim 2, wherein
the first color is cyan and the second color is magenta.

7. A reading method, comprising:
imaging a reading target;
reading, from a captured image, first information by first processing and second information by second processing different from the first processing, the first information indicated by a first symbol printed with a first digital watermark and the second information indicated by a second symbol printed with a second digital watermark and different from the first information; and
outputting read information.

8. The reading method according to claim 7, further comprising:
extracting the first symbol printed in a first color from the captured image by the first processing, and extracting the second symbol printed in a second color different from the first color from the captured image by the second processing.

9. The reading method according to claim 7, wherein
the first information is commodity identification information identifying a commodity and the second information is privilege information on a privilege of the commodity.

10. The reading method according to claim 9, wherein
the second information is flag information indicating that a label indicating a content of the privilege is attached to the commodity.

11. The reading method according to claim 9, wherein
the second information is information indicating a content of the privilege.

12. The reading method according to claim 8, wherein
the first color is cyan and the second color is magenta.

13. A POS terminal, comprising:
a payment processing component; and
a reading device, comprising:
an imaging component configured to image a reading target;
a reading component configured to read, from an image captured by the imaging component, first information by first processing and second information by second processing different from the first processing, the first information indicated by a first symbol printed with a first digital watermark and the second information indicated by a second symbol printed with a second digital watermark and different from the first information; and
an output component configured to output information read by the reading component.

14. The POS terminal according to claim 13, wherein
the reading component extracts the first symbol printed in a first color from the captured image by the first processing, and extracts the second symbol printed in a second color different from the first color from the captured image by the second processing.

15. The POS terminal according to claim 13, wherein
the first information is commodity identification information identifying a commodity and the second information is privilege information on a privilege of the commodity.

16. The POS terminal according to claim 15, wherein
the second information is flag information indicating that a label indicating a content of the privilege is attached to the commodity.

17. The POS terminal according to claim 15, wherein
the second information is information indicating a content of the privilege.

18. The POS terminal according to claim 14, wherein
the first color is cyan and the second color is magenta.

19. The POS terminal according to claim 13, wherein
the POS terminal is a self-service POS terminal.

20. The POS terminal according to claim 13, further comprising a plurality of imaging components.
